(19) United States
(12) Patent Application Publication
(10) Pub. No.: US 2025/0076684 A1
(43) Pub. Date: Mar. 6, 2025

(54) DECORATIVE EYEGLASS ASSEMBLY

(71) Applicant: Tami McFarland, Calpella, CA (US)

(72) Inventor: Tami McFarland, Calpella, CA (US)

(21) Appl. No.: 18/242,967

(22) Filed: Sep. 6, 2023

(51) Int. Cl. G02C 11/02

(52) U.S. Cl. CPC G02C 11/02

(57) ABSTRACT

A decorative eyeglass assembly for changing the outward appearance of a pair of eyeglasses includes an eyeglass frame and a decorative attachment. The eyeglass frame has a front portion and a pair of temples. A first magnetically active material covers the front portion. The decorative attachment has an inner side and an outer side. A second magnetically active material is attached to and covers the inner side, removably coupling the decorative attachment to the eyeglass frame. A decorative indicium may be applied to the outer side.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to eyeglass decorations and more particularly pertains to a new eyeglass decoration for changing the outward appearance of a pair of eyeglasses.

### (2) Description of Related Art Including Information Disclosed Under 37 CFR 1.97 and 1.98

The prior art relates to eyeglass decorations. Some prior art references disclose eyeglass frames that magnetically couple with a decorative attachment. Some decorative attachments include tinted lenses that change the standard eyeglasses into sunglasses. Other decorative attachments change the appearance of the eyeglass frames, providing a user with a wide array of eyeglass frame options without requiring the user to purchase multiple pairs of expensive prescription frames. However, the prior art references disclose eyeglass frames which only include small magnets covering or coupling a portion of the eyeglass frames to the decorative attachments. The prior art references are, accordingly, not very durable and often fall apart, particularly when a user engages in athletics or other physically strenuous activities.

### (h) BRIEF SUMMARY OF THE INVENTION

An embodiment of the disclosure meets the needs presented above by generally comprising an eyeglass set including an eyeglass frame and a decorative attachment. The eyeglass frame has a front portion and a pair of temples. A first magnetically active material covers the front portion. The first magnetically active material covers the entire front portion. The decorative attachment has an inner side and an outer side. A second magnetically active material is attached to and covers the inner side, removably coupling the decorative attachment to the eyeglass frame. A decorative indicium may be applied to the outer side.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a detailed isometric view of a decorative eyeglass assembly according to an embodiment of the disclosure.

FIG. 2 is a front side perspective view of an embodiment of the disclosure.

FIG. 3 is an exploded view of an embodiment of the disclosure.

FIG. 4 is a top isometric view of an embodiment of the disclosure.

FIG. 5 is a cross-sectional view of an embodiment of the disclosure.

FIG. 6 is an in-use view of an embodiment of the disclosure.

FIG. 7 is a detailed isometric view of an embodiment of the disclosure.

### (j) DETAILED DESCRIPTION OF THE INVENTION

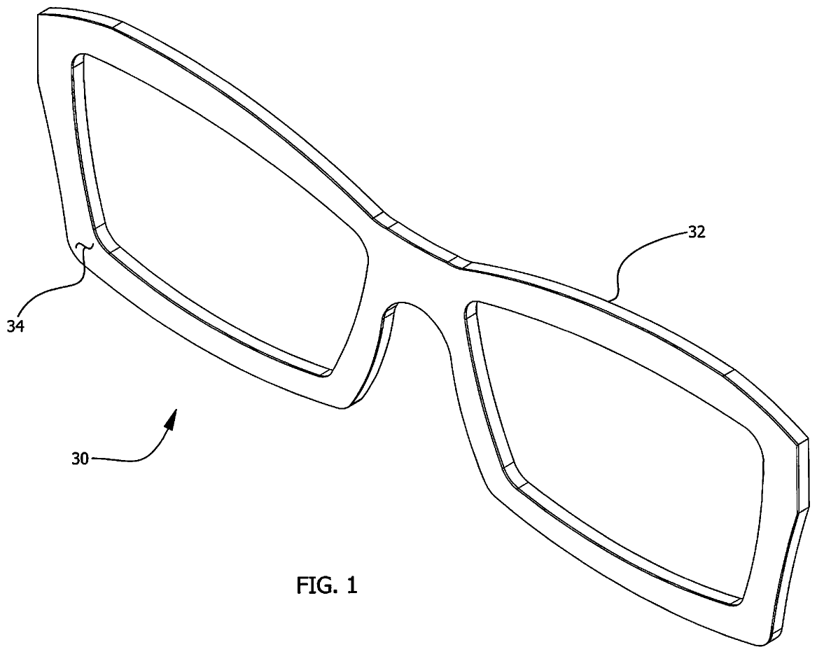

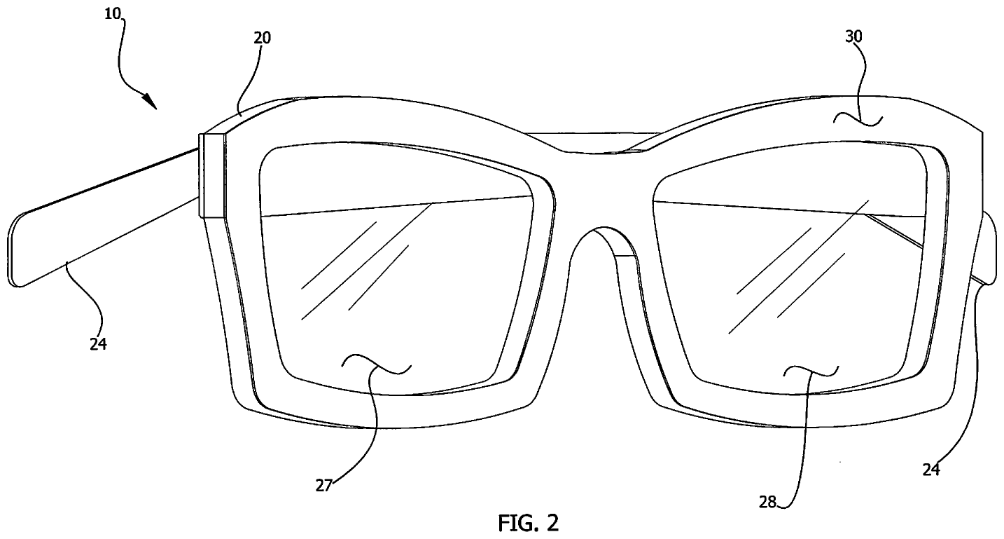

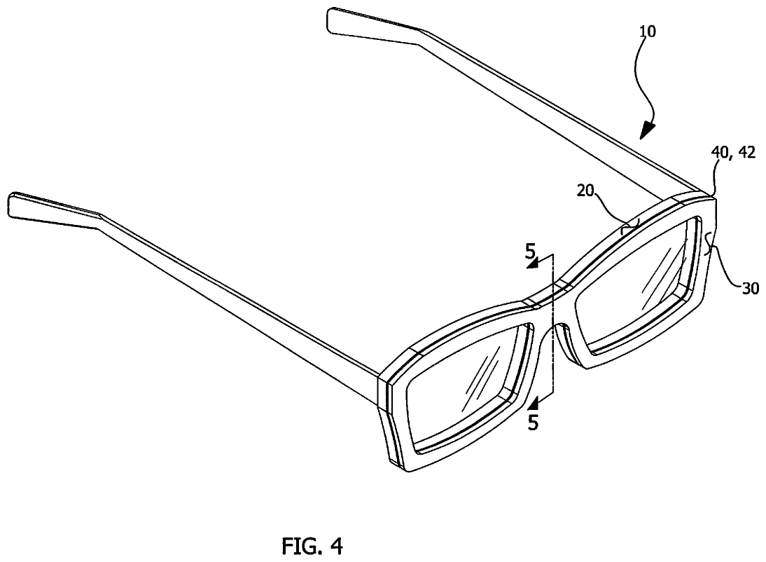

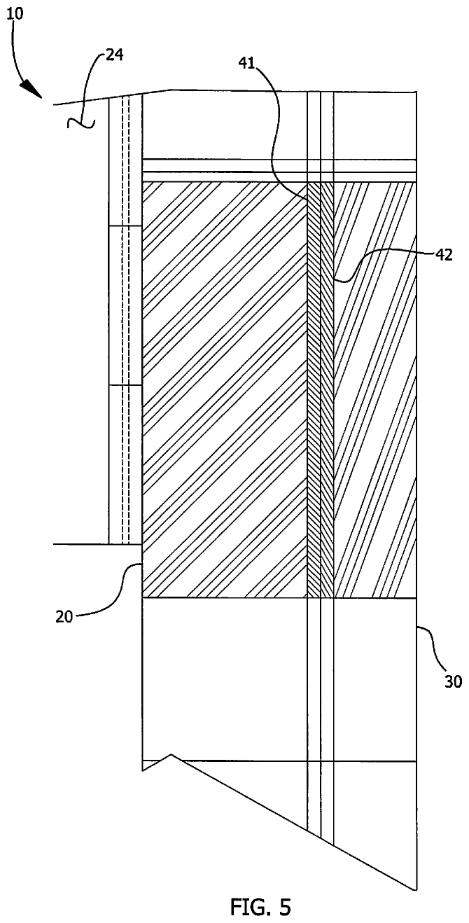

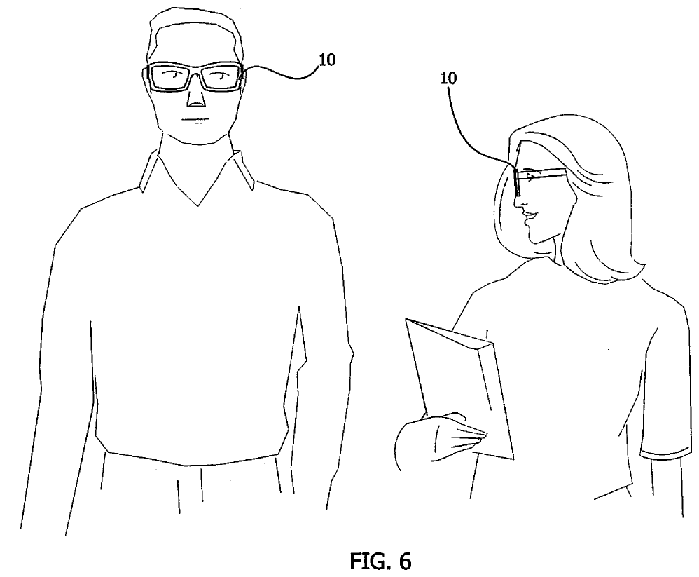

With reference now to the drawings, and in particular to FIGS. 1 through 7 thereof, a new eyeglass decorations embodying the principles and concepts of an embodiment of the disclosure and generally designated by the reference numeral 10 will be described.

As best illustrated in FIGS. 1 through 7, the decorative eyeglass assembly 10 generally comprises an eyeglass frame 20 and a decorative attachment 30. The decorative attachment 30 may be removably coupled with the eyeglass frame 20 to change the appearance of the eyeglass frame 20. This assembly 10 can be used to provide a user with a range of fashionable choices from the same eyeglass frame 20. The user will not be required to purchase multiple expensive eyeglass frames 20 to have a range of multiple options.

Generally, the eyeglass frame 20 has a front portion 22 and a pair of temples 24 laterally displaced across the front portion 22. The front portion 22 has two cutouts 26 therein. A first lens 27 and a second lens 28 are disposed within the two cutouts 26. More specifically, one of the cutouts 26 has the first lens 27 mounted therein and another of the cutouts 26 has the second lens 28 mounted therein. The first lens 27 and the second lens 28 may be of any type, such as prescription lenses, sunglass lenses, plastic lenses, blue light filtering lenses, bifocal lenses, progressive lenses, or any other type.

The pair of temples 24 are pivotably coupled to the eyeglass frame 20. Any pivotable coupling mechanism may be used, and there are numerous conventional mechanisms known in the art. For example, the pair of temples 24 may be pivotably coupled to the eyeglass frames 20 by hinges comprising joints held together by screws.

A first magnetically active material 40 covers the front portion 22. In embodiments, an entirety of the front portion 22 is covered with the first magnetically active material 40. For example, the first magnetically active material 40 may encompass the two cutouts 26, extending continuously around a perimeter of each of the two cutouts 26 and across a bridge 29 between the two cutouts 26. The first magnetically active material 40 may cover all, or nearly all, of a surface area of the front portion 22.

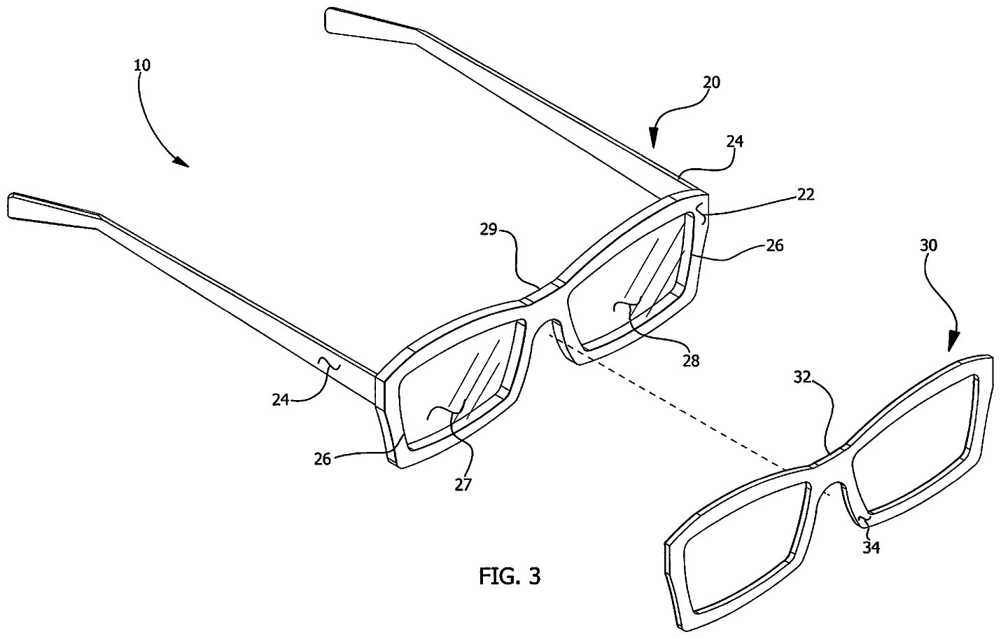

The decorative attachment 30 has an inner side 32 and an outer side 34. In some embodiments, the decorative attachment 30 has a same shape and is complementary to a frame shape of the front portion 22. For example, if the front portion 22 has a frame shape that is a cat eye frame shape, the decorative attachment 30 may also have a cat eye shape. If the front portion 22 has a square frame shape, the decorative attachment 30 may also have a square frame shape. The frame shape may alternatively be round, ovular, or any other eyeglass frame shape. Examples of such embodiments are provided in FIGS. 3, 4, and 6. In other embodiments, the decorative attachment 30 may have a different shape than the frame shape of the front portion 22. Examples of those embodiments may include a decorative attachment 30 that extends beyond the frame shape of the front portion 22.

A second magnetically active material 42 is attached to and covers the inner side 32. The first 40 and second 42 magnetically active materials are configured to be magnetically attached to each other, removably coupling the decorative attachment 30 to the eyeglass frame 20. For example, the first 40 and second 42 magnetically active materials may both comprise magnets having complementary polarity such that the first 40 and second 42 magnetically active materials are magnetically attracted to each other. In another example, one of the first 40 and second 42 magnetically active materials may comprise a magnet and the other of the first 40 and second 42 magnetically active materials may comprise a soft or hard magnetic material that is magnetically attracted to that magnet.

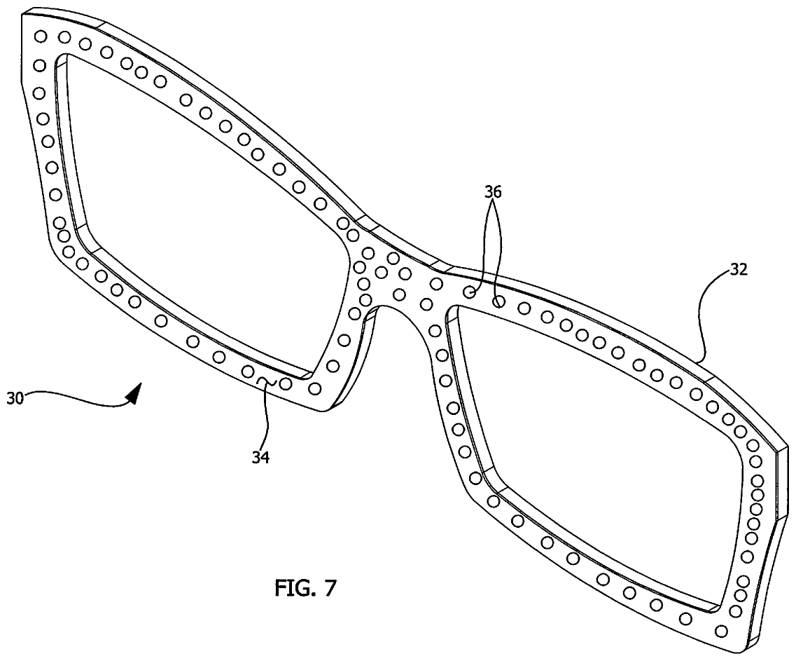

A decorative indicium 36 may be applied to the outer side 34. The decorative indicium may comprise a solid color or a pattern. In example embodiments, such as that shown in FIG. 3, the decorative indicium 36 may comprise a solid color that is the same as or different from a color of the eyeglass frame 20. In other embodiments, such as the one shown in FIG. 7, the decorative indicium 36 may comprise a pattern, such as polka dots, decorative lines, animal figures, or any other aesthetically pleasing pattern. In other examples, the decorative attachment 30 may be clear with a plurality of embedded materials comprising the decorative indicium 36, such as glitter or confetti pieces embedded within the decorative attachment 30. Any such decorative indicium 36 may be used, and a wide range of options would provide a user with a wide range of aesthetic choices for a single eyeglass frame 20.

The eyeglass frame 20 may comprise any suitable material, including plastics, metals, or combinations thereof. The decorative attachment 30 may also comprise any suitable material, including natural materials, synthetic materials, or combinations thereof.

In use, a user may affix the decorative attachment 30 to the eyeglass frame 20 to change the appearance of the decorative eyeglass assembly. In one example, the eyeglass frame 20 itself may be decorated, for example with a solid color or a pattern. The user may desire to change the appearance of the decorative eyeglass assembly, and therefore couple the decorative attachment 30 to the front portion 22 using the first 40 and second 42 magnetically active materials. Because the first 40 and second 42 magnetically active materials cover such a significant portion of the front portion 22 and the inner side 32 respectively, the decorative attachment 30 should remain stably affixed to the eyeglass frame 20. The user can engage in physical activities such as sports, hiking, boating, kayaking, or biking, just as the user would while wearing a standard set of eyeglasses. However, with the decorative eyeglass assembly 10, the user can customize their glasses to coordinate them with any mood, outfit, or occasion.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An eyeglass set, comprising:
an eyeglass frame having a front portion and a pair of temples laterally displaced across the front portion, the front portion having two cutouts therein;
a first lens and a second lens, one of the cutouts having the first lens mounted therein and another of the cutouts having the second lens mounted therein;
a first magnetically active material covering the front portion, wherein an entirety of the front portion is covered with the first magnetically active material;
a decorative attachment having an inner side and an outer side; and
a second magnetically active material being attached to and covering the inner side, the first and second magnetically active materials being magnetically attached to each other and removably coupling the decorative attachment to the eyeglass frame.

2. The eyeglass set of claim 1, wherein the pair of the temples is pivotably coupled to the eyeglass frame.

3. The eyeglass set of claim 1, wherein the decorative attachment has a same shape and is complementary to a frame shape of the front portion.

4. The eyeglass set of claim 1, further comprising a decorative indicium being applied to the outer side.

5. The eyeglass set of claim 4, the decorative indicia further comprising a solid color.

6. The eyeglass set of claim 4, the decorative indicia further comprising a pattern.

7. The eyeglass set of claim 1, the eyeglass frame further comprising a plastic material, a metal material, or combinations thereof.

8. The eyeglass set of claim 1, the decorative attachment further comprising materials including natural and synthetic materials.

9. An eyeglass set, comprising:
an eyeglass frame having a front portion and a pair of temples laterally displaced across the front portion, the front portion having two cutouts therein;
a first lens and a second lens, one of the cutouts having the first lens mounted therein and another of the cutouts having the second lens mounted therein;
the pair of the temples being pivotably coupled to the eyeglass frame;
a first magnetically active material covering the front portion, wherein an entirety of the front portion is covered with the first magnetically active material;
a decorative attachment having an inner side and an outer side, the decorative attachment having a same shape and being complementary to a frame shape of the front portion;
a second magnetically active material being attached to and covering the inner side, the first and second magnetically active materials being magnetically attached to each other and removably coupling the decorative attachment to the eyeglass frame;
a decorative indicium being applied to the outer side, the decorative indicia including a solid color;
the eyeglass frame comprising a plastic material, a metal material, or combinations thereof; and
the decorative attachment comprising materials including natural and synthetic materials.
